(19) United States
(12) Patent Application Publication
(10) Pub. No.: US 2026/0269282 A1
(43) Pub. Date: Sep. 10, 2026

(54) FUEL CELL SYSTEM

(71) Applicant: Honda Motor Co., Ltd., Tokyo (JP)

(72) Inventor: Taishi Yamaguchi, Saitama (JP)

(21) Appl. No.: 19/554,661

(22) Filed: Mar. 3, 2026

(30) Foreign Application Priority Data
Mar. 6, 2025 (JP) 2025-035836

(51) Int. Cl. H01M 8/04089; H01M 8/04082; H01M 8/0438; H01M 8/04746; H01M 8/04858; H01M 8/2483

(52) U.S. Cl. CPC H01M 8/04089; H01M 8/04201; H01M 8/04388; H01M 8/04753; H01M 8/0494; H01M 8/2483; H01M 2250/20

(57) ABSTRACT

Fuel cell system includes: fuel cell stack; first-injector and second-injector, each supplying fuel gas to fuel cell stack; and controller controlling injection of fuel gas by first-injector and second-injector. Controller: counts injection count of second-injector; when injection count is less than second-predetermined-number smaller than first-predetermined-number predetermined as upper-limit-count, performs normal-control in which injection-control is performed using first-injector and second-injector in case where required-power-generation-amount for fuel cell system is equal to or less than first-output-value, and injection-control is performed using second-injector in case where required-power-generation-amount exceeds first-output-value; and when injection count of second-injector is equal to or greater than second-predetermined-number, performs durability-adjustment-control in which injection-control is performed using first-injector in case where required-power-generation-amount is equal to or less than second-output-value corresponding to maximum-injection-amount of first-injector.

### CROSS-REFERENCE TO RELATED APPLICATION

This application is based upon and claims the benefit of priority from Japanese Patent Application No. 2025-035836 filed on Mar. 6, 2025, the content of which is incorporated herein by reference.

### BACKGROUND OF THE INVENTION

### Field of the Invention

The present invention relates to a fuel cell system.

### Description of the Related Art

By using a fuel cell as driving power for vehicles and the like, it is possible to contribute to an improvement in energy efficiency.

As a technology related to such fuel cells, a configuration is known in which multiple injectors that supply anode gas to a fuel cell are provided and injectors are specified in accordance with load conditions (see JP2016-118186A).

However, in the related art, there remains room for improvement in the durability of each injector.

### SUMMARY OF THE INVENTION

An aspect of the present invention is a fuel cell system, including: a fuel cell stack; a first injector and a second injector different from the first injector, each configured to supply fuel gas to the fuel cell stack; and a controller configured to control injection of the fuel gas by the first injector and the second injector. The controller: counts an injection count of the second injector; when the injection count of the second injector is less than a second predetermined number smaller than a first predetermined number predetermined as an upper limit count, performs a normal control in which an injection control is performed using the first injector and the second injector in a case where a required power generation amount required for the fuel cell system is equal to or less than a first output value, and the injection control is performed using the second injector in a case where the required power generation amount exceeds the first output value; and when the injection count of the second injector is equal to or greater than the second predetermined number, performs a durability adjustment control in which the injection control is performed using the first injector in a case where the required power generation amount is equal to or less than a second output value corresponding to a maximum injection amount of the first injector.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example of a configuration of a fuel cell system according to an embodiment of the invention;

FIG. 2 is a diagram for describing a relationship between a required injection amount and an injector to be used;

FIG. 3 is a flowchart illustrating a flow of switching between a normal control and a durability adjustment control and processing of injecting anode gas;

FIG. 4A is a time chart for describing an injection order of a large-diameter and a small-diameter in a low-load region of the normal control;

FIG. 4B is a time chart for describing injection performed using only the small-diameter in the durability adjustment control;

FIG. 5 is a flowchart illustrating an example of valve opening time setting processing executed by an ECU; and

FIG. 6 is a flowchart for describing a flow of switching determination between normal control and durability adjustment control according to a first modification example.

### DETAILED DESCRIPTION OF THE INVENTION

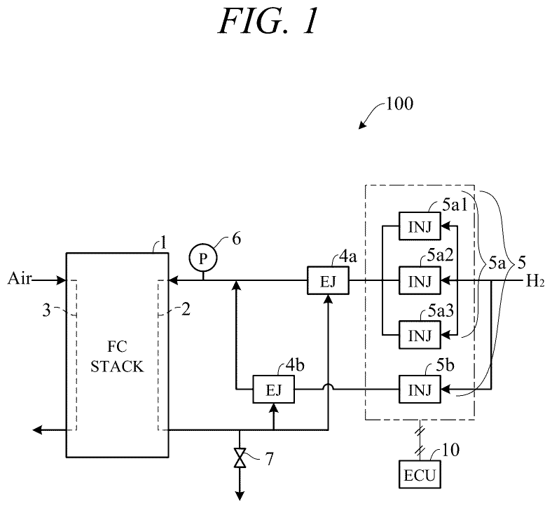

FIG. 1 is a diagram schematically illustrating an example of a configuration of a fuel cell system 100 according to an embodiment of the invention. As illustrated in FIG. 1, the fuel cell system 100 mainly includes a fuel cell (FC) stack 1 configured by stacking a plurality of power generation cells, and an Electronic Control Unit (ECU) 10 that controls respective components of the fuel cell system 100.

The fuel cell system 100 is mounted, for example, on a vehicle and generates electric power for vehicle driving. The fuel cell system 100 may also be mounted on moving bodies other than vehicles, such as aircraft and ships, as well as robots and various industrial machines.

Each power generation cell of the fuel cell stack 1 includes a Membrane Electrode Assembly (MEA) in which electrodes (such as an electrode catalyst layer and a gas diffusion layer) are provided on both surfaces of a polymer electrolyte membrane. Anode gas as a fuel gas containing hydrogen H2 is supplied to an anode electrode of each power generation cell of the fuel cell stack 1 via an anode flow path 2. A cathode gas as an oxidant gas, for example, air containing oxygen, is supplied to a cathode electrode via a cathode flow path 3. As a result, electrochemical reactions proceed at the electrodes of each power generation cell, and power generation is performed in the fuel cell stack 1.

The cathode gas supplied to the cathode flow path 3 is partially used at the cathode electrode and then discharged to the outside from the cathode flow path 3 as cathode off-gas.

A gas tank storing high-pressure anode gas is connected to the anode flow path 2 via an ejector 4a, an ejector 4b, an injector 5, and a pressure reducing valve (pressure regulating valve) not illustrated. The pressure of the anode gas in the gas tank is reduced to a predetermined supply pressure by the pressure reducing valve, and then the anode gas is injected by the injector 5.

The injector 5 includes a valve element that opens and closes an injection hole, and a coil that drives the valve element, and is controlled by the ECU 10. More specifically, drive current is supplied from a driver circuit (not illustrated) to the coil of the injector 5 in accordance with an opening and closing command from the ECU 10, thereby opening and closing the valve element of the injector 5. That is, when the coil is energized in response to an ON command from the ECU 10, the injector 5 opens, and when energization of the coil is cut off in response to an OFF command from the ECU 10, the injector 5 closes. When the injector 5 opens, the pressure-reduced anode gas is injected and supplied to the anode flow path 2 via the ejector 4a and the ejector 4b.

The anode gas supplied to the anode flow path 2 is partially used at the anode electrode and then discharged from the anode flow path 2 as anode off-gas. The anode off-gas includes, in addition to the anode gas (hydrogen), permeated nitrogen and permeated water vapor that permeate from the cathode side to the anode side through the membrane electrode assembly. The anode off-gas discharged from the anode flow path 2 is sucked in via the ejector 4a and the ejector 4b as anode recirculation gas after water is separated by a gas-liquid separator (not illustrated), and is supplied (recirculated) to the anode flow path 2 again.

The injector 5 will be described in more detail. The injector 5 includes injectors 5a (referred to as large-diameter INJ 5a) provided in parallel and an injector 5b (referred to as small-diameter INJ 5b) having a smaller hole diameter than the large-diameter INJ 5a. The effective cross-sectional area of the injection hole of the large-diameter INJ 5a is larger than the effective cross-sectional area of the injection hole of the small-diameter INJ 5b, and the injection amount per unit time of the large-diameter INJ 5a is larger than the injection amount per unit time of the small-diameter INJ 5b.

The large-diameter INJ 5a may be configured as a single injector having a larger hole diameter than the small-diameter INJ 5b, or may be configured as a plurality of injectors having the same hole diameter as the small-diameter INJ 5b. In the embodiment, an example will be described in which the large-diameter INJ 5a includes three large-diameter INJs 5a1 to 5a3 having a larger hole diameter than the small-diameter INJ 5b. The large-diameter INJs 5a1 to 5a3 are provided in parallel with each other. The anode gas injected from the large-diameter INJs 5a1 to 5a3 is supplied to the anode flow path 2 via the ejector 4a, and the anode gas injected from the small-diameter INJ 5b is supplied to the anode flow path 2 via the ejector 4b.

The anode gas injected from each injector 5 flows into a nozzle portion (not illustrated) of the ejector 4a or the ejector 4b and is accelerated, and generates a low-pressure space inside the ejector 4a and the ejector 4b, thereby sucking the anode off-gas discharged from the anode flow path 2 into the ejector 4a and the ejector 4b. The anode gas and the anode off-gas that have merged inside the ejector 4a and the ejector 4b are discharged via a diffuser portion (not illustrated) of the ejector 4a and the ejector 4b while undergoing accompanying mixing, and are supplied to the anode flow path 2. Hereinafter, a mixed gas discharged from the ejector 4a and the ejector 4b and supplied to the anode flow path 2 will be referred to as “anode supply gas”. The anode supply gas includes anode gas (hydrogen), permeated nitrogen, and permeated water vapor.

A pressure sensor 6 that detects a pressure P of the anode supply gas supplied to the fuel cell stack 1 is provided near an inlet of the anode flow path 2. Specifically, the pressure sensor 6 detects a pressure (total pressure) of the anode supply gas including the anode gas. A hydrogen partial pressure of the anode supply gas corresponding to the pressure P of the anode gas (hydrogen) can be calculated by subtracting a nitrogen partial pressure and a water vapor partial pressure of the anode supply gas from the pressure (total pressure) detected by the pressure sensor 6.

The nitrogen partial pressure and the water vapor partial pressure of the anode supply gas can be calculated based on a flow rate (permeation amount) of permeated nitrogen and permeated water vapor and a discharge amount of anode recirculation gas described later. The permeation amount can also be calculated based on a power generation state such as a power generation amount (current value) of the fuel cell stack 1 and a stack temperature.

An opening/closing valve 7 that opens and closes a purge passage branched from a recirculation passage connecting the anode flow path 2 with the ejector 4a and the ejector 4b is provided near an outlet of the anode flow path 2. The opening/closing valve 7 is normally closed. When a nitrogen concentration (relative nitrogen partial pressure) of the anode supply gas increases and a hydrogen concentration (relative hydrogen partial pressure) of the anode supply gas decreases, the opening/closing valve 7 opens temporarily. When the opening/closing valve 7 opens, part of anode recirculation gas flowing through the recirculation passage is discharged (purged) to the purge passage, thereby suppressing a decrease in the hydrogen concentration of the anode supply gas and maintaining the hydrogen concentration at a predetermined level or more. The opening/closing valve 7 is controlled by the ECU 10.

The ECU 10 includes a computer having a CPU, a RAM, a ROM, an I/O interface, and other peripheral circuits. Sensors such as the pressure sensor 6, an accelerator opening degree sensor of a vehicle, and a temperature sensor that detects a temperature of the fuel cell stack 1 are connected to the ECU 10, and detected values from the respective sensors are input to the ECU 10. In addition, respective components of the fuel cell system 100 such as the injector 5 and the opening/closing valve 7 are connected to the ECU 10, and the ECU 10 controls the respective components of the fuel cell system 100 including the injector 5. Required power generation amount for the fuel cell system 100 is input to the ECU 10 via, for example, an accelerator opening degree sensor of a vehicle.

### Calculation of Required Injection Amount Q

The ECU 10 calculates a flow rate (required injection amount) Q of anode gas to be supplied to the anode flow path 2 of the fuel cell stack 1 based on the required power generation amount. More specifically, the ECU 10 calculates the required power generation amount of the fuel cell system 100 based on an accelerator opening degree detected by the accelerator opening degree sensor and the like, and calculates a flow rate (power-generation consumption amount) of anode gas (hydrogen) consumed per unit time by power generation in the fuel cell stack 1. The ECU 10 also calculates a flow rate (permeation amount) of permeated hydrogen that permeates from the anode side to the cathode side through the membrane electrode assembly, a discharge amount of anode recirculation gas, a pressure fluctuation of a target pressure P0 of anode gas, and a feedback amount of the pressure P with respect to the target pressure P0. Then, the ECU 10 calculates the required injection amount Q by adding the feedback amount to the calculated power-generation consumption amount, permeation amount, discharge amount, and pressure fluctuation (feedforward amount).

In the embodiment, a combination of the injectors 5 to be used is changed in accordance with a magnitude of the required injection amount Q, and a flow rate (that is, an injection amount by the injectors 5) of anode gas is varied. For example, in a normal state, in a low-load region and a medium-load region excluding a high-load region in which the required power generation amount for the fuel cell stack 1 is large, injection using two large-diameter INJs 5a1 and 5a2 and one small-diameter INJ 5b is performed as normal control.

However, in the normal control, injection counts tend to be uneven between the large-diameter INJs 5a1 and 5a2 and the small-diameter INJ 5b constituting the injector 5, and there is a possibility that the large-diameter INJs 5a1 and 5a2 that reach an upper limit value NL of injection counts in design may appear at an early stage. Therefore, injection counts of the respective injectors 5 are counted, and when the large-diameter INJs 5a1 and 5a2 approaching the upper limit value NL appear, control in which only the small-diameter INJ 5b, which has a lower injection frequency than the large-diameter INJs 5a1 and 5a2 in the normal control, is used is performed as durability adjustment control. By the durability adjustment control, unevenness in injection counts among the plurality of injectors 5 is suppressed, and it becomes possible to extend an operation time of the injectors 5 in the fuel cell system 100. Such normal control and durability adjustment control will be further described.

### Overview of Combination of Required Injection Amount and Injector

In the embodiment, the upper limit value NL (may also be referred to as an upper limit count) of injection counts in design of the large-diameter INJ 5a is set as a first predetermined number, and 90% (0.9×NL) of the upper limit value NL is set as a second predetermined number. Then, injection counts of the respective large-diameter INJs 5a are counted, and when a large-diameter INJ 5a whose count value exceeds the second predetermined number appears, durability adjustment control is performed in place of normal control.

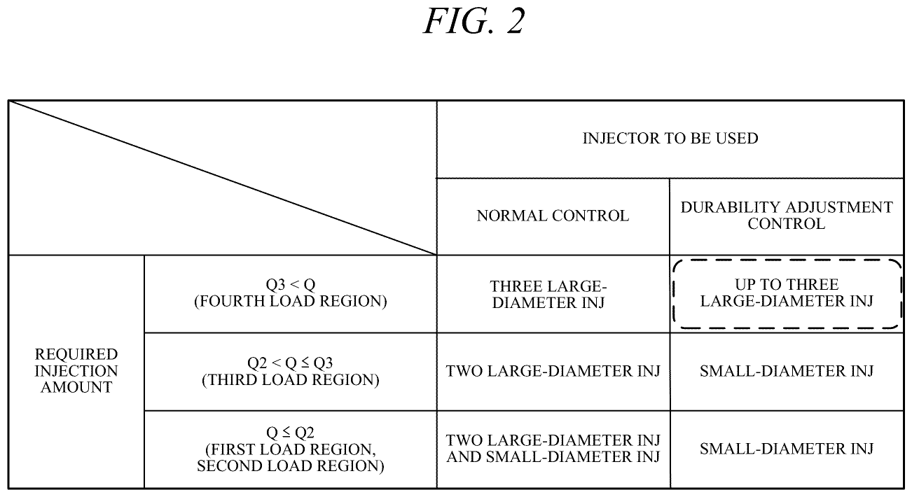

FIG. 2 is a diagram for describing a relationship between the required injection amount Q and the injector 5 to be used.

### 1. Case of Normal Control

In the normal control, as illustrated in FIG. 2, in a first load region (Q≤Q1) in which a required power generation amount (load) for the fuel cell stack 1 is small and the required injection amount Q is equal to or less than Q1, and in a second load region (Q1<Q≤Q2) in which the required power generation amount for the fuel cell stack 1 is slightly small and the required injection amount Q is greater than Q1 and equal to or less than Q2, injection is performed using two large-diameter INJs 5a1 and 5a2 and the small-diameter INJ 5b.

In addition, in a third load region (Q2<Q≤Q3) in which the required power generation amount for the fuel cell stack 1 is slightly large and the required injection amount Q is greater than Q2 and equal to or less than Q3, injection is performed using only two large-diameter INJs 5a1 and 5a2.

Furthermore, in a fourth load region (Q3<Q) in which the required power generation amount for the fuel cell stack 1 is large and the required injection amount Q is greater than Q3, injection is performed using only three large-diameter INJs 5a1 to 5a3.

### 2. Case of Durability Adjustment Control

In the durability adjustment control, as illustrated in FIG. 2, in the first load region (Q≤Q1) in which the required injection amount Q is equal to or less than Q1 and in the second load region (Q1<Q≤Q2) in which the required injection amount Q is greater than Q1 and equal to or less than Q2, injection is performed using only the small-diameter INJ 5b.

In addition, in the third load region (Q2<Q≤Q3) in which the required injection amount Q is greater than Q2 and equal to or less than Q3, injection is performed using only the small-diameter INJ 5b.

Furthermore, in the fourth load region (Q3<Q) in which the required injection amount Q is greater than Q3, injection is performed using only up to three large-diameter INJs 5a1 to 5a3. It is also possible to prohibit injection in the fourth load region (Q3<Q) (that is, to prohibit injection in a region surrounded by a dashed line in FIG. 2).

According to FIG. 2, by the durability adjustment control, injection of the large-diameter INJs 5a1 to 5a3 is restricted, whereby unevenness in injection counts among the plurality of injectors 5 is suppressed, and it becomes possible to extend an operation time of the injectors 5 in the fuel cell system 100.

### Description of Flowchart

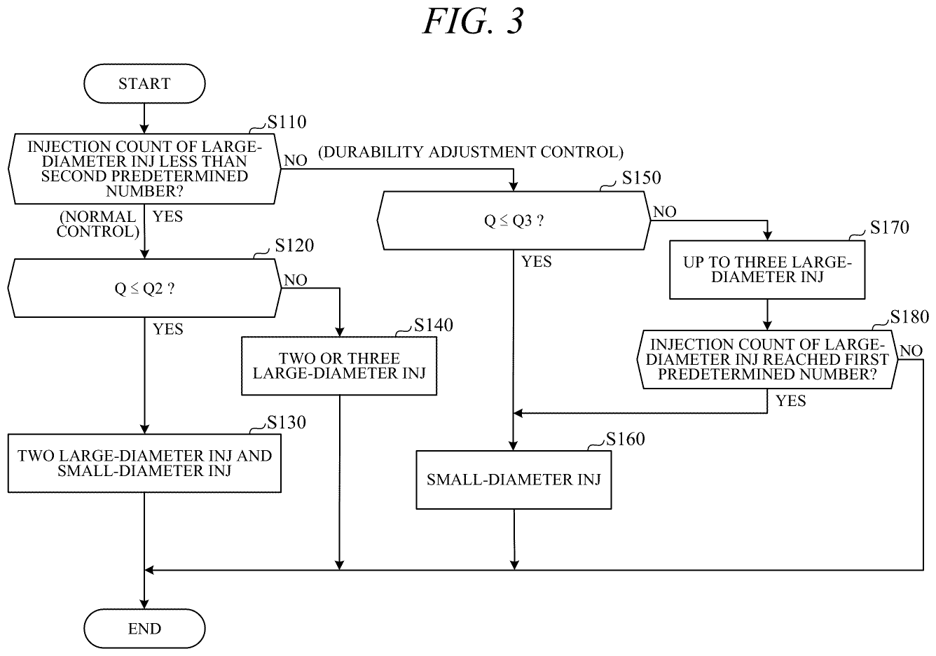

FIG. 3 is a flowchart illustrating a flow of switching between the normal control and the durability adjustment control and processing of deciding the injector 5 to be used for injection of anode gas and injecting the anode gas. The ECU 10 executes the processing of FIG. 3 each time anode gas is injected by the injector 5.

In S110 (S: processing step) of FIG. 3, the ECU 10 determines whether injection counts of the large-diameter INJ 5a are less than the second predetermined number described above. When the injection counts of the large-diameter INJ 5a are less than the second predetermined number, the ECU 10 makes an affirmative determination in S110, proceeds to S120, and decides the normal control. On the other hand, when the injection counts of the large-diameter INJ 5a reach the second predetermined number, the ECU 10 makes a negative determination in S110, proceeds to S150, and decides the durability adjustment control.

S120 to S140 correspond to the normal control. In S120, the ECU 10 determines whether the required injection amount Q is equal to or less than Q2. In a case where Q≤Q2 is satisfied, the ECU 10 makes an affirmative determination in S120 and proceeds to S130, and in a case where Q≤Q2 is not satisfied, the ECU 10 makes a negative determination in S120 and proceeds to S140.

In S130, the ECU 10 performs injection using two large-diameter INJs 5a and the small-diameter INJ 5b, and ends the processing of FIG. 3.

In S140, the ECU 10 performs injection using two or three large-diameter INJs 5a, and ends the processing of FIG. 3.

S150 to S180 correspond to the durability adjustment control. In S150, the ECU 10 determines whether the required injection amount Q is equal to or less than Q3. In a case where Q≤Q3 is satisfied, the ECU 10 makes an affirmative determination in S150 and proceeds to S160, and in a case where Q≤Q3 is not satisfied, the ECU 10 makes a negative determination in S150 and proceeds to S170.

Here, the injection amount Q3 may be set as the maximum injection amount Qib of the small-diameter INJ 5b. In a case of proceeding to S160, a current value as an output upper limit of the fuel cell system 100 is limited to a value corresponding to the maximum injection amount Qib.

In S160, the ECU 10 performs injection using only the small-diameter INJ 5b, and ends the processing of FIG. 3.

In S170, the ECU 10 tentatively decides to use up to three large-diameter INJs 5 and proceeds to S180.

In S180, the ECU 10 determines whether injection counts of the large-diameter INJ 5a have reached the first predetermined number described above. When the injection counts of the large-diameter INJ 5a reach the first predetermined number, the ECU 10 makes an affirmative determination in S180 and proceeds to S160. In a case of proceeding to S160, injection of the large-diameter INJ 5a is prohibited (in other words, the tentatively decided content is discarded) and only the small-diameter INJ 5b is used, so that an injection amount of anode gas is limited, at maximum, to the maximum injection amount Qib of the small-diameter INJ 5b×the maximum valve opening time Tib_max.

On the other hand, in a case where the injection counts of the large-diameter INJ 5a do not reach the first predetermined number, the ECU 10 makes a negative determination in S180. In a case where a negative determination is made, injection is performed using up to three large-diameter INJs 5 as tentatively decided in S170, and the processing of FIG. 3 is ended.

Details of injection will be described below.

### Setting of Injection Period Tint

The ECU 10 calculates a current value based on the required power generation amount for the fuel cell system 100, and also calculates a hydrogen partial pressure (pressure P of anode gas (hydrogen)) of anode supply gas based on the pressure (total pressure) of the anode supply gas detected by the pressure sensor 6 and the like. Then, by referring to a predetermined characteristic map, the ECU 10 calculates (sets) an injection period Tint in accordance with the calculated current value and the calculated hydrogen partial pressure of the anode supply gas. The injection period Tint is set to become shorter as the current value becomes larger in a high-load condition and also to become shorter as the hydrogen partial pressure of the anode supply gas becomes smaller.

### Calculation of Maximum Injection Amount Qi of Each Injector

The ECU 10 calculates the maximum injection amount Qi that each injector 5 can inject per unit time. Each injector 5 is controlled by pulse width modulation (PWM). An injection amount of anode gas injected by each injector 5 in one valve opening is adjusted by changing a duty ratio (Ti/Tint), which is a ratio of a valve opening time (pulse width) Ti to a period (injection period) Tint of a pulse waveform. The maximum injection amount Qi of each injector 5 is an injection amount in a case where the duty ratio is set to 100%.

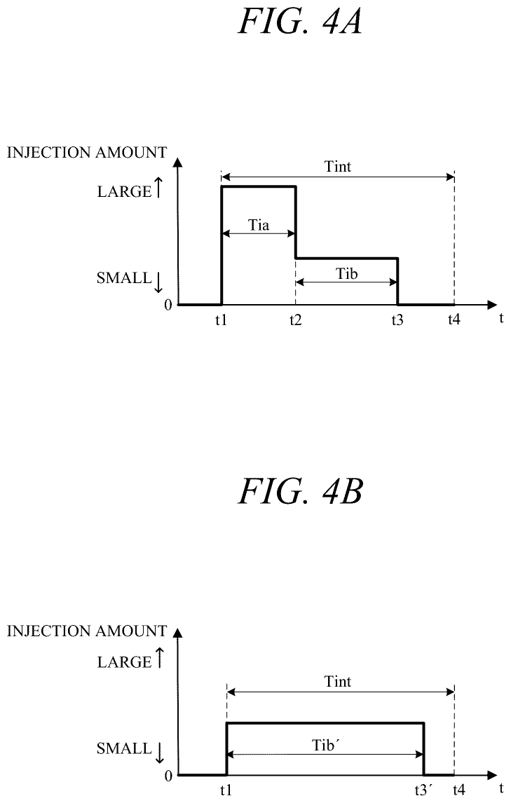

FIG. 4A is a time chart for describing an injection order of the large-diameter INJ 5a and the small-diameter INJ 5b in the low-load region (Q≤Q2) of the normal control. As illustrated in FIG. 4A, when the injection period Tint is set at time t1, in the set injection period Tint, first, the large-diameter INJ 5a opens and injection of anode gas by the large-diameter INJ 5a starts. Thereafter, at time t2, when a valve opening time Tia of the large-diameter INJ 5a corresponding to the duty ratio elapses, the large-diameter INJ 5a closes and injection of anode gas by the large-diameter INJ 5a stops, and at the same time, the small-diameter INJ 5b opens and injection of anode gas by the small-diameter INJ 5b starts. Thereafter, at time t3, when a valve opening time Tib of the small-diameter INJ 5b corresponding to the duty ratio elapses, the small-diameter INJ 5b closes and injection of anode gas by the small-diameter INJ 5b stops.

In a case where, for example, two large-diameter INJs 5a1 and 5a2 are used as the large-diameter INJ 5a, the two large-diameter INJs 5a1 and 5a2 are controlled to open and close simultaneously. When two large-diameter injectors (any two of 5a1 to 5a3) are used, an effective cross-sectional area of the injection hole of the large-diameter INJ 5a becomes twice that of one large-diameter INJ 5a1.

The ECU 10 calculates a maximum injection amount Qia(2) of two large-diameter injectors (any two of 5a1 to 5a3) and a maximum injection amount Qib of the small-diameter INJ 5b, respectively. The maximum injection amount Qi can be calculated by the following expression using an effective cross-sectional area S of each injector 5, a pressure Pinj, a temperature Tinj, a specific heat ratio γ of hydrogen, and a gas constant R.

$$Qi = S \times Pinj / R / Tinj \times γ \times \{ 2 / ( γ + 1 ) \} \hat{} \{ ( γ + 1 ) / ( γ - 1 ) \}$$

FIG. 4B is a time chart for describing injection performed using only the small-diameter INJ 5b in the durability adjustment control. As illustrated in FIG. 4B, when the injection period Tint is set at time t1, in the set injection period Tint, the small-diameter INJ 5b opens and injection of anode gas by the small-diameter INJ 5b starts. Thereafter, at time t3′, when a valve opening time Tib′ of the small-diameter INJ 5b corresponding to the duty ratio elapses, the small-diameter INJ 5b closes and injection of anode gas by the small-diameter INJ 5b stops.

### Calculation of Valve Opening Time Ti of Each Injector

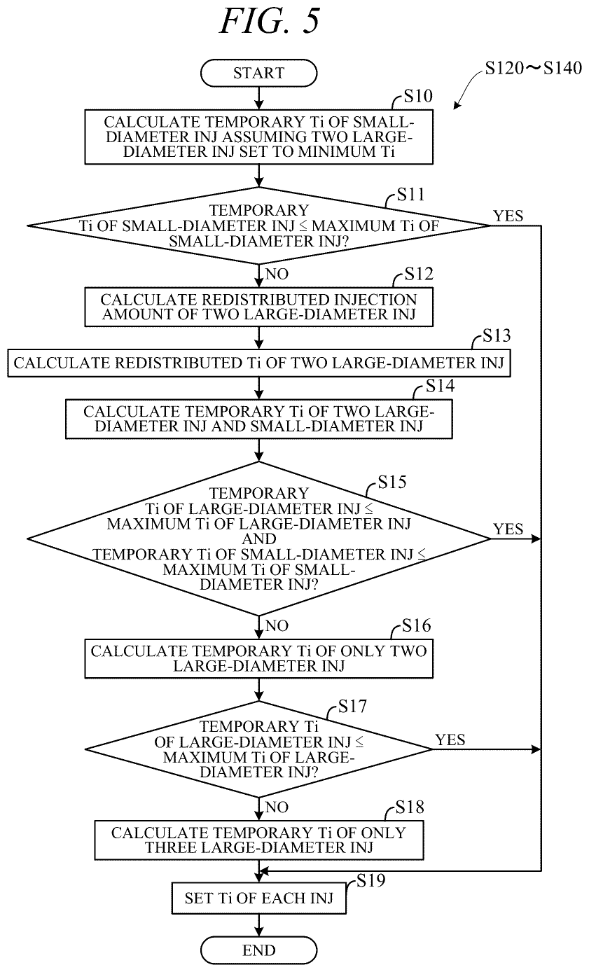

FIG. 5 is a flowchart illustrating an example of valve opening time setting processing executed by the ECU 10. Processing in FIG. 5 corresponds to processing in S120 to S140 in FIG. 3.

### Valve Opening Time Ti When Two Large-Diameter Injectors and Small-Diameter Injector are Used (When Valve Opening Time of Large-Diameter Injector is Set to Minimum Valve Opening Time)

As illustrated in FIG. 5, first, in S10, temporary valve opening times Ti_tmp of respective injectors 5 are calculated on an assumption that two large-diameter INJs 5a1 and 5a2 and the small-diameter INJ 5b are used. In S10, a temporary valve opening time Tia_tmp of the large-diameter INJ 5a is set to a predetermined minimum valve opening time Tia_min (for example, approximately 12 ms), and a temporary valve opening time Tib_tmp of the small-diameter INJ 5b is calculated.

More specifically, using the injection period Tint, the maximum injection amount Qia(2) of two large-diameter INJs 5a1 and 5a2, and the minimum valve opening time Tia_min of the large-diameter INJ 5a, a minimum injection amount Qia_min of two large-diameter INJs 5a1 and 5a2 is calculated by the following expression.

$$Qia\_min = Tia\_min / Tint \times Qia ( 2 )$$

Then, using the calculated minimum injection amount Qia_min of two large-diameter INJs 5a1 and 5a2, the required injection amount Q, the injection period Tint, and the maximum injection amount Qib of the small-diameter INJ 5b, a temporary valve opening time Tib_tmp of the small-diameter INJ 5b is calculated by the following expression.

$$Tib\_tmp / Tint \times Qib = Q - Qia\_min$$

Next, in S11, it is determined whether the temporary valve opening time Tib_tmp of the small-diameter INJ 5b calculated in S10 is equal to or less than the maximum valve opening time Tib_max of the small-diameter INJ 5b. The maximum valve opening time Ti_max of each injector 5 is determined as a shorter one of a time corresponding to a predetermined ratio (for example, approximately 95%) of the injection period Tint and a time obtained by subtracting the minimum valve opening time Ti_min from the injection period Tint.

In a case where an affirmative determination is made in S11, the processing proceeds to S19, and a valve opening time Tia of the large-diameter INJ 5a is set to the minimum valve opening time Tia_min, and a valve opening time Tib of the small-diameter INJ 5b is set to the temporary valve opening time Tib_tmp calculated in S10. When the valve opening times Ti of respective injectors 5 are set in S19, respective injectors 5 are controlled to inject anode gas based on the set valve opening times Ti.

### Valve Opening Time Ti When Two Large-Diameter Injectors and Small-Diameter Injector are Used (When Valve Opening Time of Large-Diameter Injector is Set to be Greater Than Minimum Valve Opening Time)

On the other hand, in a case where a negative determination is made in S11, the processing proceeds to S12, and a redistributed injection amount Qia_red to be injected by two large-diameter INJs 5a1 and 5a2 in addition to injection at the minimum valve opening time Tia_min is calculated. More specifically, using the maximum injection amount Qib of the small-diameter INJ 5b, the temporary valve opening time Tib_tmp of the small-diameter INJ 5b, and the maximum valve opening time Tib_max of the small-diameter INJ 5b, the redistributed injection amount Qia_red is calculated by the following expression.

$$Qia\_red = Qib \times ( Tib\_tmp - Tib\_max )$$

Next, in S13, a redistributed valve opening time Tia_red during which two large-diameter INJs 5a1 and 5a2 are to continue to open (inject) beyond the minimum valve opening time Tia_min is calculated. More specifically, using the redistributed injection amount Qia_red calculated in S12, the maximum injection amount Qia(2) of two large-diameter INJs 5a1 and 5a2, and the maximum injection amount Qib of the small-diameter INJ 5b, the redistributed valve opening time Tia_red is calculated by the following expression.

$$Tia\_red = Qia\_red / ( Qia ( 2 ) - Qib )$$

Next, in S14, temporary valve opening times Ti_tmp of respective injectors 5 are calculated on an assumption that two large-diameter INJs 5a1 and 5a2 and the small-diameter INJ 5b are used. More specifically, using the minimum valve opening time Tia_min of the large-diameter INJ 5a, the maximum valve opening time Tib_max of the small-diameter INJ 5b, and the redistributed valve opening time Tia_red calculated in S13, a temporary valve opening time Tia_tmp of the large-diameter INJ 5a and a temporary valve opening time Tib_tmp of the small-diameter INJ 5b are calculated by the following expressions.

$$Tia\_tmp = Tia\_min + Tia\_red$$

$$Tib\_tmp = Tib\_max - Tia\_red$$

Next, in S15, it is determined whether the temporary valve opening time Tia_tmp of the large-diameter INJ 5a calculated in S14 is a predetermined valve opening time (for example, equal to or less than the maximum valve opening time Tia_max of the large-diameter INJ 5a) and whether the temporary valve opening time Tib_tmp of the small-diameter INJ 5b is equal to or less than the maximum valve opening time Tib_max of the small-diameter INJ 5b. The predetermined valve opening time is not limited to the maximum valve opening time Tia_max of the large-diameter INJ 5a and may be a fixed value separately set by testing or the like. In a case where an affirmative determination is made in S15, the processing proceeds to S19, and valve opening times Tia and Tib of respective INJs 5a and 5b are set to the temporary valve opening times Tia_tmp and Tib_tmp calculated in S14.

Instead of processing in S15, it may be determined whether the present current value (power generation current value) of the fuel cell stack 1 is equal to or greater than a predetermined current value, and in a case where an affirmative determination is made, the processing may proceed to S16, and in a case where a negative determination is made, the processing may proceed to S19. That is, under operation conditions in which a power generation state stabilizes whether the small-diameter INJ 5b is used or only the large-diameter INJ 5a is used without using the small-diameter INJ 5b when the power generation current value is equal to or greater than the predetermined current value, an operation count of the small-diameter INJ 5b is reduced, deterioration due to wear of the small-diameter INJ 5b is minimized, and power generation stability of the fuel cell stack 1 is enhanced.

### Valve Opening Time Ti When Only Two Large-Diameter Injectors are Used

On the other hand, when a negative determination is made in S15, the processing proceeds to S16, and a temporary valve opening time Tia_tmp on an assumption that only two large-diameter INJs 5a1 and 5a2 are used is calculated. More specifically, using the required injection amount Q, the injection period Tint, and the maximum injection amount Qia(2) of two large-diameter INJs 5a1 and 5a2, the temporary valve opening time Tia_tmp of the large-diameter INJ 5a is calculated by the following expression.

$$Tia\_tmp / Tint \times Qia ( 2 ) = Q$$

Next, in S17, it is determined whether the temporary valve opening time Tia_tmp of the large-diameter INJ 5a calculated in S16 is equal to or less than a predetermined valve opening time (for example, the maximum valve opening time Tia_max of the large-diameter INJ 5a). When an affirmative determination is made in S17, the processing proceeds to S19, a valve opening time Tia of the large-diameter INJ 5a is set to the temporary valve opening time Tia_tmp calculated in S16, and a valve opening time Tib of the small-diameter INJ 5b is set to “0”. Instead of processing in S17, it may be determined whether a power generation current value of the fuel cell stack 1 is equal to or greater than a predetermined current value, and in a case where an affirmative determination is made, the processing may proceed to S18, and in a case where a negative determination is made, the processing may proceed to S19.

### Valve Opening Time Ti When Only Three Large-Diameter Injectors are Used

On the other hand, when a negative determination is made in S17, the processing proceeds to S18, and a temporary valve opening time Tia_tmp on an assumption that only three large-diameter INJs 5a1 to 5a3 are used is calculated. More specifically, using the required injection amount Q, the injection period Tint, and the maximum injection amount Qia(3) of three large-diameter INJs 5a1 to 5a3, the temporary valve opening time Tia_tmp of the large-diameter INJ 5a is calculated by the following expression. Next, in S19, the valve opening time Tia of the large-diameter INJ 5a is set to the temporary valve opening time Tia_tmp calculated in S18, the valve opening time Tib of the small-diameter INJ 5b is set to “0”, and processing according to FIG. 5 ends.

$$Tia\_tmp / Tint \times Qia ( 3 ) = Q$$

### Combination of Required Injection Amount Q and Injector in Normal Control

In the first load region (Q≤Q1) in FIG. 2, the temporary valve opening time Tib_tmp of the small-diameter INJ 5b calculated in S10 in FIG. 5 becomes equal to or less than the maximum valve opening time Tib_max (affirmative determination in S11). In such a first load region, injection is performed using two large-diameter INJs 5a1 and 5a2 and the small-diameter INJ 5b, and a valve opening time Tia of the large-diameter INJ 5a is set to the minimum valve opening time Tia_min.

In the second load region (Q1<Q≤Q2) in FIG. 2, the temporary valve opening time Tib_tmp of the small-diameter INJ 5b calculated in S10 in FIG. 5 becomes greater than the maximum valve opening time Tib_max (negative determination in S11). In addition, the temporary valve opening time Tia_tmp of the large-diameter INJ 5a calculated in S14 becomes equal to or less than the maximum valve opening time Tia_max (affirmative determination in S15). In such a second load region, injection is performed using two large-diameter INJs 5a1 and 5a2 and the small-diameter INJ 5b, and the valve opening time Tia of the large-diameter INJ 5a is set to be longer than the minimum valve opening time Tia_min.

In the low-load region (Q≤Q2), the valve opening time Ti per injection period Tint tends to be shorter than that in the high-load region (Q>Q2), and a time during which injection is not performed (Tint−Ti) tends to become longer, and thus drainage in the anode flow path 2 may be hindered. In such a low-load region, the small-diameter INJ 5b, which requires a longer valve opening time Ti for the same injection amount than the large-diameter INJ 5a, is preferentially used, and the valve opening time Tib of the small-diameter INJ 5b is set to be longer than the valve opening time Tia of the large-diameter INJ 5a (Tia<Tib).

Accordingly, the valve opening time Ti(=Tia+Tib) per injection period Tint can be lengthened, and water (liquid) staying in the anode flow path 2 can be smoothly discharged to the outside of the fuel cell stack. In addition, by preferentially using the small-diameter INJ 5b, even in a case where an injection count of the injector 5 increases due to interrupt injection, deterioration due to wear of the large-diameter INJ 5a, which is essential for securing the required injection amount Q, can be minimized.

In the third load region (Q2<Q≤Q3) in FIG. 2, the temporary valve opening time Tib_tmp of the small-diameter INJ 5b calculated in S10 in FIG. 5 becomes greater than the maximum valve opening time Tib_max, and the temporary valve opening time Tia_tmp of the large-diameter INJ 5a calculated in S14 becomes greater than the maximum valve opening time Tia_max (negative determinations in S11 and S15). In addition, the temporary valve opening time Tia_tmp of the large-diameter INJ 5a calculated in S16 becomes equal to or less than the maximum valve opening time Tia_max (affirmative determination in S17). In such a third load region, injection is performed using only two large-diameter INJs 5a1 and 5a2.

In the fourth load region (Q3<Q) in FIG. 2, the temporary valve opening time Tib_tmp of the small-diameter INJ 5b calculated in S10 in FIG. 5 becomes greater than the maximum valve opening time Tib_max, the temporary valve opening time Tia_tmp of the large-diameter INJ 5a calculated in S14 becomes greater than the maximum valve opening time Tia_max, and the temporary valve opening time Tia_tmp of the large-diameter INJ 5a calculated in S16 becomes greater than the maximum valve opening time Tia_max (negative determinations in S11, S15, and S17). In such a fourth load region, injection is performed using only three large-diameter INJs 5a1 to 5a3.

In the high-load region (Q>Q2), the valve opening time Ti per injection period Tint tends to become longer than that in the low-load region (Q≤Q2). In such a high-load region, only the large-diameter INJ 5a, which requires a shorter valve opening time Ti for the same injection amount than the small-diameter INJ 5b, is used, and the valve opening time Ti(=Tia) per injection period Tint is shortened. Accordingly, while preferentially using the small-diameter INJ 5b, the required injection amount Q can be reliably injected within the injection period Tint even in the high-load region (Q>Q2), and the required power generation amount can be obtained.

### Combination of Required Injection Amount Q and Injector in Durability Adjustment Control

In the first and second load regions (Q≤Q2) in FIG. 2, injection is performed using only one small-diameter INJ 5b. Then, in accordance with the required injection amount Q, the small-diameter INJ 5b is set within a range equal to or less than the maximum injection amount Qib and equal to or less than the maximum valve opening time Tib_max.

Similarly, in the third load region (Q2<Q≤Q3) in FIG. 2, injection is performed using only one small-diameter INJ 5b. Then, in accordance with the required injection amount Q, the small-diameter INJ 5b is set within a range equal to or less than the maximum injection amount Qib and equal to or less than the maximum valve opening time Tib_max.

In the fourth load region (Q3<Q), injection is performed using only up to three large-diameter INJs 5a1 to 5a3. Then, in accordance with the required injection amount Q, the large-diameter INJ 5a is set to a range equal to or less than the maximum injection amount Qia and equal to or less than the maximum valve opening time Tia_max.

Note that, by presetting, injection in the fourth load region (Q3<Q) may be prohibited, and an upper limit of the required injection amount Q may be limited to Q3of the third load region.

According to the embodiment described above, the following advantageous effects are obtained.
(1) The fuel cell system 100 according to the embodiment includes the fuel cell stack 1, the large-diameter INJ 5a and the small-diameter INJ 5b that supply anode gas to the fuel cell stack 1, and the ECU 10 that controls injection of anode gas by the large-diameter INJ 5a and the small-diameter INJ 5b. The injector 5 includes the small-diameter INJ 5b and large-diameter INJs 5a1 to 5a3 different from the small-diameter INJ 5b. The ECU 10 as a controller counts an injection count of the large-diameter INJ 5a. When the injection count of the large-diameter INJ 5a is less than the second predetermined number (0.9×NL) smaller than the first predetermined number (upper limit value NL) predetermined as an upper limit count, the ECU 10 performs normal control in which injection control is performed using the small-diameter INJ 5b and the large-diameter INJ 5a in a case where the required power generation amount required for the fuel cell system 100 is equal to or less than a predetermined first output value (in other words, in a case where the required injection amount Q based on the required power generation amount is equal to or less than an injection amount Q2 corresponding to the first output value), and injection control is performed using the large-diameter INJ 5a in a case where the required power generation amount exceeds the first output value (in other words, in a case where the required injection amount Q exceeds Q2), and when the injection count of the large-diameter INJ 5a is equal to or greater than the second predetermined number, the ECU 10 performs durability adjustment control in which injection control is performed using the small-diameter INJ 5b in a case where the required power generation amount is equal to or less than a second output value corresponding to the maximum injection amount Qib of the small-diameter INJ 5b (in other words, in a case where the required injection amount Q is equal to or less than the maximum injection amount Qib of the small-diameter INJ 5b).

With this configuration, when an injection count of the large-diameter INJ 5a approaches the upper limit count, a usage frequency of the large-diameter INJ 5a is suppressed, and compared with a case where durability adjustment control is not performed, it becomes possible to extend an operation time of the injector 5 in the fuel cell system 100.
(2) In the fuel cell system 100 according to (1) above, the ECU 10 calculates a required amount of anode gas on the basis of the required injection amount Q based on the required power generation amount, and in a case where the required power generation amount in the normal control is equal to or less than the first output value, the ECU 10 allocates a predetermined temporary injection amount of the required amount to the large-diameter INJ 5a as a second injection amount, and allocates a remainder obtained by subtracting the second injection amount from the required amount to the small-diameter INJ 5b as a first injection amount, and the first injection amount is smaller than the maximum injection amount Qib of the small-diameter INJ 5b.

With this configuration, in the normal control, the first injection amount smaller than the maximum injection amount Qib of the small-diameter INJ 5b is allocated to the small-diameter INJ 5b.
(3) In the fuel cell system 100 according to (1) above, in a case where the required power generation amount in the durability adjustment control exceeds the second output value (in other words, in a case where the required injection amount Q based on the required power generation amount exceeds the maximum injection amount Qib of the small-diameter INJ 5b), the ECU 10 performs injection control using the large-diameter INJ 5a.

With this configuration, a usage frequency of the large-diameter INJ 5a is suppressed, and compared with a case where durability adjustment control is not performed, it becomes possible to extend an operation time of the injector 5 in the fuel cell system 100.
(4) In the fuel cell system 100 according to (3) above, when an injection count of the large-diameter INJ 5a in the durability adjustment control reaches the first predetermined number (upper limit value NL) determined as an upper limit count, the ECU 10 prohibits injection control using the large-diameter INJ 5a and performs injection control using the small-diameter INJ 5b.

With this configuration, even in a case where the injection count of the large-diameter INJ 5a reaches the upper limit count, it becomes possible to continue power generation of the fuel cell system 100 using the small-diameter INJ 5b.
(5) In the fuel cell system 100 according to (3) above, when an injection count of the large-diameter INJ 5a in the durability adjustment control reaches the first predetermined number (upper limit value NL) determined as an upper limit count, the ECU 10 sets an output upper limit value of the fuel cell system 100 to the second output value (value corresponding to the maximum injection amount Qib of the small-diameter INJ 5b).

With this configuration, even in a case where the injection count of the large-diameter INJ 5a reaches the upper limit count, it becomes possible to continue power generation of the fuel cell system 100 using the small-diameter INJ 5b.
(6) In the fuel cell system 100 according to (1) to (5) above, the large-diameter INJ 5a has a larger injection amount than the small-diameter INJ 5b.

With this configuration, by using the small-diameter INJ 5b having a smaller injection count to suppress a usage frequency of the large-diameter INJ 5a, it becomes possible to extend an operation time of the injector 5 in the fuel cell system 100.

The embodiment described above can be modified into various forms. Hereinafter, modification examples will be described.

### FIRST MODIFICATION EXAMPLE

In a case where the durability adjustment control according to the embodiment described above is performed, it is assumed that an increase in an injection count of the small-diameter INJ 5b constituting the injector 5 progresses, and the small-diameter INJ 5b reaches an upper limit value NL2 of an injection count of the small-diameter INJ 5b on a design basis earlier than the large-diameter INJ 5a reaches an upper limit value NL of an injection count of the large-diameter INJ 5a on a design basis.

Accordingly, in the first modification example, every time an injection count of the large-diameter INJ 5a in the normal control reaches a third predetermined number (for example, 25% (0.25×NL) of the upper limit value NL) smaller than 90% (0.9×NL) of the upper limit value NL as the second predetermined number, switching is performed from the normal control to the durability adjustment control to count an injection count of the small-diameter INJ 5b, and every time the injection count of the small-diameter INJ 5b in the durability adjustment control reaches a fifth predetermined number (for example, 0.25×NL2) smaller than a fourth predetermined number (for example, the upper limit value NL2) predetermined as an upper limit count, switching is performed from the durability adjustment control to the normal control.

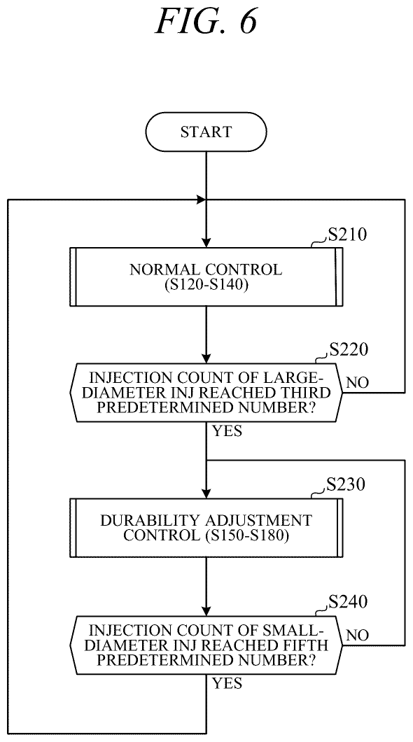

FIG. 6 is a flowchart for describing a flow of switching determination between normal control and durability adjustment control according to the first modification example. The ECU 10 executes processing according to FIG. 6 in parallel with, for example, processing according to the flowchart illustrated in FIG. 3.

In S210 in FIG. 6, the ECU 10 performs normal control (corresponding to processing in S120 to S140 in FIG. 3) and proceeds to S220.

In S220, the ECU 10 determines whether an injection count of the large-diameter INJ 5a in the normal control has reached the third predetermined number. Every time the injection count of the large-diameter INJ 5a reaches the third predetermined number, the ECU 10 makes an affirmative determination in S220 and proceeds to S230 to switch to durability adjustment control. On the other hand, in a case where the injection count of the large-diameter INJ 5a does not reach the third predetermined number, the ECU 10 returns to S210. In a case of returning to S210, the normal control is continued.

In S230, the ECU 10 performs durability adjustment control (corresponding to processing in S150 to S180 in FIG. 3) and proceeds to S240.

In S240, the ECU 10 determines whether an injection count of the small-diameter INJ 5b in the durability adjustment control has reached the fifth predetermined number. Every time the injection count of the small-diameter INJ 5b reaches the fifth predetermined number, the ECU 10 makes an affirmative determination in S240 and returns to S210 to switch to the normal control. On the other hand, in a case where the injection count of the small-diameter INJ 5b does not reach the fifth predetermined number, the ECU 10 returns to S230. In a case of returning to S230, the durability adjustment control is continued.

According to the first modification example, it becomes possible to align timings at which respective injection counts of the large-diameter INJ 5a and the small-diameter INJ 5b approach their respective upper limit values NL and NL2. As a result, replacement timings of the large-diameter INJ 5a and the small-diameter INJ 5b become substantially the same, and compared with a case where replacement of the large-diameter INJ 5a and replacement of the small-diameter INJ 5b are performed at different timings, it becomes possible to reduce maintenance effort for the fuel cell system 100.

### SECOND MODIFICATION EXAMPLE

In a case where two of the three large-diameter INJs 5a are used (for example, in S130 and S140 in the normal control), in order to prevent the same large-diameter INJ 5a from being used in a biased manner, “round-robin” selection of the large-diameter INJs 5a may be performed such that large-diameter INJs 5a are selected in a combination not used in the previous injection.

In a case where two of the three large-diameter INJs 5a are used, three combinations exist: the large-diameter INJ 5a1 and the large-diameter INJ 5a2, the large-diameter INJ 5a1 and the large-diameter INJ 5a3, and the large-diameter INJ 5a2 and the large-diameter INJ 5a3. The ECU 10 selects two large-diameter INJs 5a in a combination different from that used in the previous injection and causes injection of anode gas to be performed.

In the second modification example, during injection control by the large-diameter INJ 5a as the second injector, the ECU 10 selects, as at least one of the large-diameter INJs 5a to be subjected to the current injection control, another large-diameter INJ 5a different from the large-diameter INJ 5a subjected to the previous injection control.

With this configuration, according to the second modification example, it becomes possible to suppress bias in injection counts among the INJs 5a1 to 5a3 constituting the plurality of large-diameter INJs 5a. That is, it becomes possible to align timings at which respective injection counts approach the upper limit value NL of the injection count of the large-diameter INJ 5a. As a result, replacement timings of respective large-diameter INJs 5a become substantially the same, and compared with a case where replacement of respective large-diameter INJs 5a is individually performed each time, it becomes possible to reduce maintenance effort for the fuel cell system 100.

The above embodiment can be combined as desired with one or more of the aforesaid modifications. The modifications can also be combined with one another.

According to the present invention, it becomes possible to extend an operation time of an injector in a fuel cell system.

Above, while the present invention has been described with reference to the preferred embodiments thereof, it will be understood, by those skilled in the art, that various changes and modifications may be made thereto without departing from the scope of the appended claims.

1. A fuel cell system, comprising:
a fuel cell stack;
a first injector and a second injector different from the first injector, each configured to supply fuel gas to the fuel cell stack; and
a controller configured to control injection of the fuel gas by the first injector and the second injector, wherein
the controller:
counts an injection count of the second injector;
when the injection count of the second injector is less than a second predetermined number smaller than a first predetermined number predetermined as an upper limit count, performs a normal control in which an injection control is performed using the first injector and the second injector in a case where a required power generation amount required for the fuel cell system is equal to or less than a first output value, and the injection control is performed using the second injector in a case where the required power generation amount exceeds the first output value; and
when the injection count of the second injector is equal to or greater than the second predetermined number, performs a durability adjustment control in which the injection control is performed using the first injector in a case where the required power generation amount is equal to or less than a second output value corresponding to a maximum injection amount of the first injector.

2. The fuel cell system according to claim 1, wherein
the controller:
calculates a required amount of the fuel gas based on the required power generation amount; and
in a case where the required power generation amount in the normal control is equal to or less than the first output value, allocates a temporary injection amount of the required amount to the second injector as a second injection amount, and allocates a remainder obtained by subtracting the second injection amount from the required amount to the first injector as a first injection amount, wherein
the first injection amount is smaller than the maximum injection amount of the first injector.

3. The fuel cell system according to claim 1, wherein
in a case where the required power generation amount in the durability adjustment control exceeds the second output value, the controller performs the injection control using the second injector.

4. The fuel cell system according to claim 3, wherein
when the injection count of the second injector in the durability adjustment control reaches the first predetermined number, the controller prohibits the injection control using the second injector and performs the injection control using the first injector.

5. The fuel cell system according to claim 3, wherein
when the injection count of the second injector in the durability adjustment control reaches the first predetermined number, the controller sets an output upper limit value of the fuel cell system to the second output value.

6. The fuel cell system according to claim 5, wherein
the controller:
switches from the normal control to the durability adjustment control to count the injection count of the first injector every time the injection count of the second injector in the normal control reaches a third predetermined number smaller than the second predetermined number; and
switches from the durability adjustment control to the normal control every time the injection count of the first injector in the durability adjustment control reaches a fifth predetermined number smaller than the fourth predetermined number predetermined as an upper limit count.

7. The fuel cell system according to claim 1, wherein
the second injector has a larger injection amount than the first injector.

8. The fuel cell system according to claim 7, wherein
the second injector includes a plurality of injectors, wherein
in the injection control using the second injector, the controller selects, as a current injector to be subjected to a current injection control, an injector different from a previous injector subjected to a previous injection control.
